(19) United States
(12) Patent Application Publication
(10) Pub. No.: US 2003/0031109 A1
(43) Pub. Date: Feb. 13, 2003

(54) Optical disc and method of recording and reproducing essential information of the optical disc

(75) Inventors: Kyung-geun Lee, Gyeonggi-do (KR); In-sik Park, Gyeonggi-do (KR); Du-seop Yoon, Gyeonggi-do (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-City (KR)

(21) Appl. No.: 10/098,071

(22) Filed: Mar. 15, 2002

(30) Foreign Application Priority Data
Aug. 9, 2001 (KR) 2001-47957

(51) Int. Cl. G11B 7/00

(52) U.S. Cl. 369/59.25; 369/52.1; 369/273; 369/275.2; 369/283

(57) ABSTRACT

An optical disc and a method of recording essential information in and reproducing the essential information from an optical disc are provided. The optical disc includes a pattern of crystalline and amorphous marks representing the essential information. The essential information recording method includes heating an amorphous recording layer above the temperature of crystallization by radiating a laser beam according to a photoelectrically converted signal, and slowly cooling the heated recording layer to the temperature of crystallization or below to form the pattern of crystalline and amorphous marks. The essential information reproducing method includes radiating the beam onto the pattern of crystalline and amorphous marks in which the essential information of the optical disc is recorded, receiving the beam reflected from the pattern of crystalline and amorphous marks and photoelectrically converting the received beam into a detected signal, filtering the detected signal through a high-pass filter, and reproducing the essential information of the optical disc from the filtered signal. The essential information can be recorded in a recordable optical disc by phase change using a conventional disc initializing apparatus after deposition of a recording layer and before initialization of the optical disc. Therefore, an additional recording apparatus and process is not necessary, and no damage caused by a high energy of the laser beam occurs in the optical disc.

### CROSS-REFERENCE TO RELATED APPLICATIONS

This application claims the benefit of Korean application No. 2001-47957, filed Aug. 9, 2001, in the Korean Industrial Property Office, the disclosure of which is incorporated herein by reference.

### BACKGROUND OF THE INVENTION

1. Field of the Invention

The present invention relates to an optical disc and method of recording essential information on and reproducing the essential information from an optical disc, and more particularly, to a recordable optical disc in which the essential information is recorded by phase change, and method of recording the essential information in and reproducing the essential information from the optical disc.

2. Description of the Related Art

Optical discs, which are a kind of a recording medium in which information is recorded or from which the information is reproduced by light radiation, are classified into a read only memory type, a write once read many type, a random access memory type, a rewritable type, and the like according to recording and reproducing methods. The optical discs are also classified into a single-layer disc and a dual-layer disc according to the number of information recording layers.

The single-layer disc has only one information layer regardless of whether the single-layer disc is a single-sided or double-sided disc, and information is reproduced by reflecting an incident laser beam at a reflective layer formed on the information layer.

The dual-layer disc has two layers each including the information layer regardless of whether the dual-layer disc is a single-sided or double-sided disc: a first layer includes a semi-transparent layer, and a second layer includes a reflective layer. The information of the first layer is reproduced by light reflected from the semi-transparent layer while the information of the second layer is reproduced by light reflected from the reflective layer after having transmitted through the semi-transparent layer.

The optical discs are also classified into a single-sided disc and a double-sided disc according to the structure of the information layers on a substrate. The single-sided disc has an information layer on only one side of the substrate while the double-sided disc has the information layers on both sides of the substrate. Accordingly, the double-sided disc has the same recording capacity as two single-sided discs. The single-sided and double-sided discs are manufactured as a single-layer or dual-layer disc, as described above.

Also, the optical discs are categorized into a compact disc, a digital versatile disc, a next-generation DVD and the like according to recording capacity: 650 MB for the CD, 4.7 GB for the DVD, and 4.7 GB or greater for the next-generation DVD.

The specifications of such optical discs differ from one another according to the recording capacity. The CD and DVD have the same diameter of 120 mm but have a different substrate thickness of 1.2 mm for the CD, 0.6 mm for the DVD, and about 0.1 mm for the next-generation DVD. A laser beam of 780 nm and an objective lens having a numerical aperture of 0.4 are used for the CD, and a 650-nm laser beam and a 0.6-NA objective lens are used for the DVD. A blue laser beam and a 0.85-NA objective lens are used for the next-generation DVD.

The general physical structure of such an optical disc is divided, from the center of the optical disc, into a clamping area, a burst cutting area, a lead-in area, a data area, and a lead-out area.

The clamping area is an annular area located at a central portion of the optical disc to which clamping force is applied with a clamping tool. The data area includes a user area, a spare area, and a guide area. User data are recorded in the data area. The lead-in area and the lead-out area are located inside and outside the data area having sectors, respectively.

An area where BCA codes are formed is specified as a BCA field or a BCA. The BCA codes for recording essential information on optical discs, such as a serial number, date of manufacture and the like, are recorded in an area not used for recording the user data and located closer to a center of the optical disc than the lead-in area. In general, the BCA is located between the clamping area and the lead-in area and extends about 1 mm in a radial direction. For the DVD-R/RW or the CD-R/RW, a power calibration area and a program memory area are located between the BCA and the lead-in area. The BCA for the DVD-R/RW or the CD-R/RW has a radial length of about 0.8 mm.

In most optical discs, the BCA codes are recorded in the BCA in the form of a barcode mark by partially burning away the recording layer.

FIGS. 1A-1D are diagrams illustrating a method of recording the BCA codes in and reproducing the BCA codes from a conventional single-layer optical disc disclosed in U.S. Pat. No. 6,208,736, to Gotoh et al., issued Mar. 27, 2001. Referring to FIG. 1A, the BCA codes are recorded in the conventional optical disc 1 in the form of a barcode mark by burning away a portion of a reflective layer 13 formed on a substrate 11 with a laser beam 21. In forming the barcode mark, a pulsed laser beam such as a yttrium-aluminum-garnet laser beam is focused on the reflective layer 13 through a focusing lens to burn away the reflective layer 13, thereby forming a non-reflective portion 10. In FIG. 1A, reference numeral 15 denotes an adhesive layer, reference numeral 17 denotes a protective layer, and reference numeral 19 denotes a print layer on which a label may be printed.

In FIG. 1B, a waveform 2 is detected from the conventional single-layer optical disc 1 including the non-reflective portion 10. Because the non-reflective portion 10 has zero reflectivity so that the waveform 2 detected from the non-reflective portion 10 is less than a second slice level. The reflectivity of the periphery region of the non-reflective portion 10 is sinusoidal and has an average level equal to a first slice level.

In FIG. 1C, a waveform 3, which is obtained by slicing the waveform 2, represents a marking detection signal. The marking detection signal generally represents the location of an address, the number of frame synchronous signals, the number of read clocks, etc. Here, the waveform 3 represents the physical location of a particular address. A waveform 4 of FIG. 1D represents read clocks obtained from the marking detection signal by synchronization.

FIGS. 2A-2G are diagrams illustrating another method of recording BCA codes in and reproducing the BCA codes from a conventional dual-layer optical disc. Referring to FIG. 2A, in the conventional dual-layer optical disc 20, the BCA codes are recorded in the form of a barcode mark by burning away portions of reflective layers 13a and 13b, which are formed on first and second substrates 11a and 11b, respectively, with a laser beam 21. As shown in FIG. 2A, the BCA codes are recorded as a pattern of a non-reflective portion 10a or 10b and the remaining reflective portions. In FIG. 2A, a reference numeral 15 denotes an adhesive layer, and a reference numeral 17 denotes a protective layer.

In FIG. 2B, a waveform 22 is reproduced from a first layer, which includes the reflective layer 13a and the first substrate 11a, of the conventional dual-layer optical disc 20. A waveform 23 of FIG. 2C, which is obtained by slicing the waveform 22, represents a marking detection signal. A waveform 24 of FIG. 2D represents read clocks obtained from the marking detection signal of the waveform 23 by synchronization.

In FIG. 2E, a waveform 25 is reproduced from a second layer, which includes the reflective layer 13b and the second substrate 11b, of the conventional dual-layer optical disc 20. A waveform 26 of a marking detection signal is obtained by slicing the waveform 25 as shown in FIG. 2F. A waveform 27 of FIG. 2G represents read clocks obtained from the marking detection signal of the waveform 26 by synchronization.

FIG. 3A shows bar code marks formed in a circle in the BCA of a conventional optical disc. A signal used to record data “01000” 34 in FIG. 3D has a waveform 33 of FIG. 3C. Bar code marks 31a and 31b, as shown in the BCA 32 of FIG. 3B, are formed by the waveform 33. A signal reproduced from the bar code marks 31a and 31b has a waveform 35 of FIG. 3E. When a low-frequency component is passed through a low-pass filter, a waveform 36 of FIG. 3F is obtained. By reproducing the waveform 36, data “01000” 37 of FIG. 3B, which is identical to the record data 34 of FIG. 3D, is obtained.

In the conventional optical discs, the BCA codes are recorded as barcode marks by burning away a reflective layer of the disc with a high-intensity beam, such as the YAG laser beam, to cause a physical deformation to the reflective layer. However, this recording method causes a problem when applied to thinner optical discs.

In particular, when the BCA codes are recorded in the next-generation DVD, that is as thin as 0.1 mm, by the same method applied to the conventional optical disc, the protective layer is damaged by beam energy so that a desired pattern of the barcode marks cannot be formed. For a dual-layer optical disc that includes a dielectric layer having a high thermal absorbance, the optical disc is damaged by easily absorbing the heat of a high-energy laser beam so that a desired pattern of marks cannot be formed.

In addition, the BCA codes can be recorded in a recordable optical disc by using phase change. In this case, a separate BCA code recording process should follow an initialization process and thus needs an additional BCA cord recording apparatus. This additional process for recording the BCA codes increases processing time consumption.

### SUMMARY OF THE INVENTION

To solve the above-described problems, it is an object of the present invention to provide an optical disc in which essential information is recorded by phase change.

It is another object of the present invention to provide a method of recording essential information on an optical disc within a short period of time using an existing optical pickup apparatus, without causing any damage by laser beam energy.

It is still another object of the present invention to provide a method of reproducing essential information from an optical disc by using a conventional optical pickup apparatus, which can be applied to reproduce the essential information from any recording layer of a recordable dual-layer optical disc.

Additional objects and advantages of the invention will be set forth in part in the description which follows and, in part, will be obvious from the description, or may be learned by practice of the invention.

To achieve the above and other objects of the present invention, there is provided an optical disc in which essential information is recorded as a pattern of crystalline and amorphous marks.

The above and other objects of the present invention are also achieved by providing a multi-layer optical disc in which the essential information is recorded in one of a plurality of recording layers as a pattern of crystalline and amorphous marks. The crystalline and amorphous marks are in the form of barcodes extending in a radial direction, forming a circle around the center of the multi-layer optical disc. Preferably, the crystalline mark has a higher reflectivity than the amorphous mark. Preferably, the crystalline mark has the reflectivity of no less than 20%.

To achieve the above and other objects of the present invention, there is provided a method of recording essential information in an optical disc, the method comprising heating an amorphous recording layer above the temperature of crystallization by radiating a beam according to a photoelectrically converted signal, and slowly cooling the heated recording layer to the temperature of crystallization or below to form a pattern of crystalline and amorphous marks. In this case, the optical disc may comprise a plurality of recording layers. Preferably, the crystalline and amorphous marks are in the form of barcodes extending in a radial direction, forming a circle around the center of the optical disc. Preferably, the crystalline mark has the higher reflectivity than the amorphous mark. Preferably, the crystalline mark has the reflectivity no less than 20%.

To achieve the above and other objects of the present invention, there is provided a method of reproducing the essential information from the optical disc, the method comprising radiating a beam onto a pattern of crystalline and amorphous marks in which essential information of the optical disc is recorded, receiving the beam reflected from the pattern of crystalline and amorphous marks and photoelectrically converting the received beam to detect a signal, filtering the detected signal through a high-pass filter, and reproducing the essential information of the optical disc from the filtered signal.

The crystalline and amorphous marks are in the form of barcodes extending in a radial direction, forming a circle around the center of the optical disc. Preferably, the crystalline mark has the higher reflectivity than the amorphous mark. Preferably, the crystalline mark has the reflectivity of no less than 20%.

In the present invention, the pattern of crystalline and amorphous marks refers to an arrangement of crystalline and amorphous marks in an essential information area of a recordable optical disc, which is achieved by forming a crystalline mark in a layer that is amorphous when deposited on the optical disc capable of recording data by phase change.

The optical disc capable of data record by phase change refers to an optical disc from which a signal can be detected from a variation in reflectivity between crystalline and amorphous phases of the optical recording medium.

When the information is recorded in a data area of an optical disc, a high-power laser beam with a narrow pulse width is radiated to heat the recording layer to a melting temperature to thereby make the recording layer amorphous. Next, the heated recording layer is rapidly cooled to maintain the amorphous phase, thereby resulting in an amorphous information mark in the data area.

When the information is erased from the data area of the optical disc, a low-power laser beam with a wide pulse width is radiated to heat the recording layer to a crystallization temperature, and then the recording layer is slowly cooled to form a regular crystalline lattice so that the information is erased from the data area.

According to the present invention, the principle of recording information in and reproducing information from the data area of an optical disc, described above, is applied to record and erase the essential information of a recordable optical disc, but the record and erase phases in the EIA are opposite to those in the data area.

According to the present invention, the recording of the essential information in and initialization of a recordable optical disc, in which information can be recorded by phase change, can be performed in the conventional optical pickup apparatus. Also, the present invention uses a laser diode commonly used in optical pickup apparatuses so that a problem of disc damage caused by the high-intensity laser beam in the conventional BCA code recording method can be solved. In particular, for multi-layer optical discs, the essential information can be reproduced when the layer containing the essential information is radiated by a laser beam, regardless of which layer includes the essential information.

The essential information of the optical disc according to the present invention may be recorded in any code including a BCA code.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIGS. 1A-1D are diagrams illustrating a conventional method of recording;

FIGS. 2A-2G are diagrams illustrating a conventional method of recording the BCA codes in and reproducing the BCA codes from a dual-layer optical disc;

FIG. 3A shows a conventional optical disc including barcode marks;

FIGS. 3B-3G show signals for barcode marks formed as the BCA codes in the optical disc of FIG. 3A;

FIG. 4 is a sectional view of an optical disc according to an embodiment of the present invention;

FIG. 5 is a flowchart illustrating a method of recording essential information in an optical disc according to the embodiment of FIG. 4;

FIGS. 6A-6C illustrate respective states of the optical disc for recording the essential information in the optical disc according to the embodiment of FIG. 5;

FIG. 7A shows power levels of a laser beam applied to record the essential information in the optical disc by the method according to the present invention;

FIG. 7B shows the temperature of a recording layer in recording the essential information in the optical disc by the method according to the present invention;

FIG. 8 is a flowchart illustrating a method of reproducing the essential information from the optical disc according to another embodiment of the present invention;

FIG. 9 is a sectional view of an optical disc according to another embodiment of the present invention;

FIG. 10 illustrates a read signal obtained by an essential information reproducing method according to the present invention;

FIG. 11 shows a multi-layer optical disc according to another embodiment of the present invention;

FIGS. 12A and 12B are plan and sectional views, respectively, of an optical disc according to another embodiment of the present invention in which barcode type marks are formed;

FIG. 12C shows a mark signal reproduced from the barcode type marks formed in the optical disc of FIGS. 12A and 12B;

FIG. 13A shows an optical disc according to another embodiment of the present invention with barcode type marks in a protective layer; and

FIGS. 13B and 13C shows mark signals read from the barcode type marks formed in the optical disc of FIG. 13A.

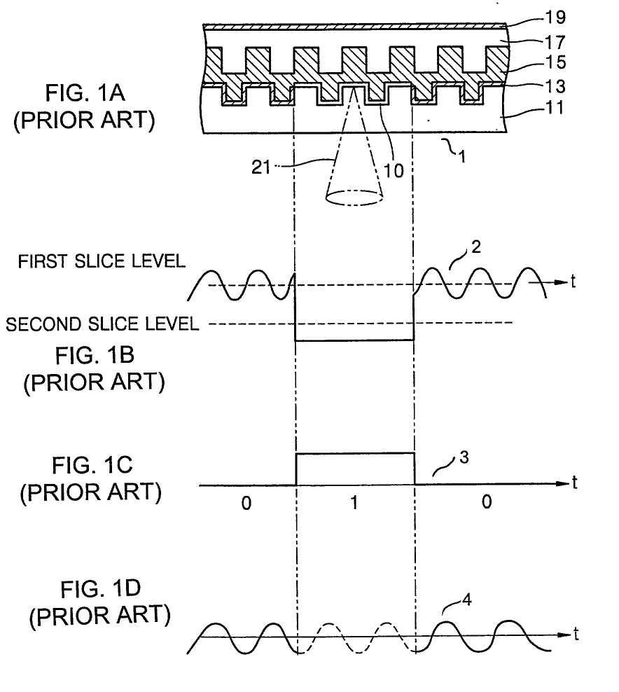

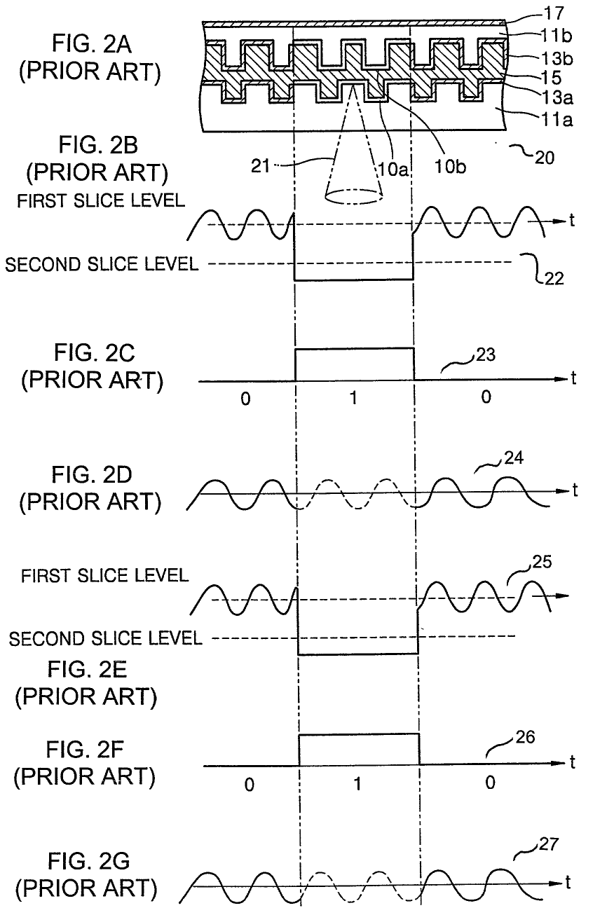

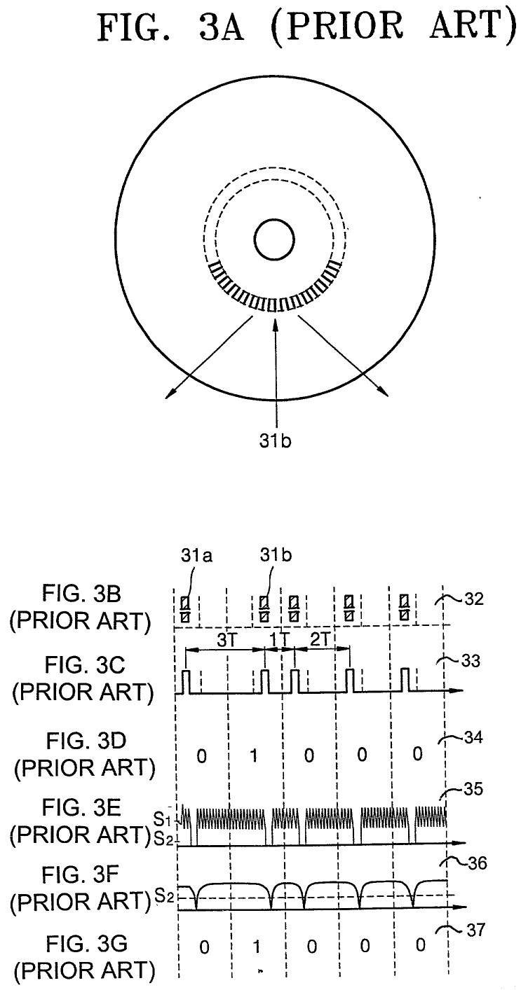

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

Preferred embodiments of an optical disc and methods of recording essential information in and reproducing the essential information from the optical disc by phase change will be described in greater detail with reference to the appended drawings.

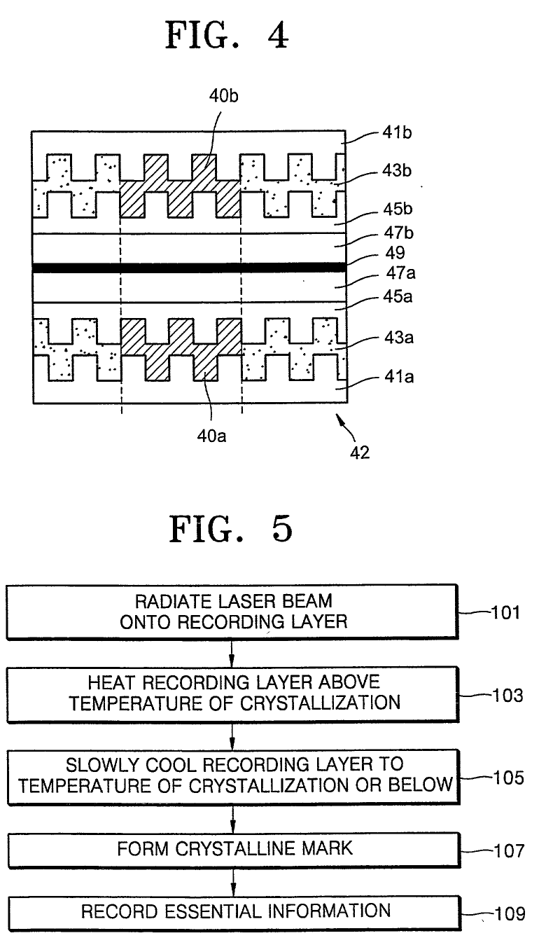

FIG. 4 shows an optical disc 42 according to an embodiment of the present invention. In the optical disc 42 shown in FIG. 4, which is a recordable digital versatile disc, recording layers 43a and 43b are formed on first and second substrates 41a and 41b, respectively. A reflective layer 45a and a protective layer 47a are formed on the recording layer 43a, and a reflective layer 45b and a protective layer 47b are formed on the recording layer 43b. The first and second substrates 41a and 41b are bonded to each other in a symmetrical structure by an adhesive layer 49.

As shown in FIG. 4, crystalline marks 40a and 40b are formed in the recording layers 43a and 43b, respectively. As described above, the present invention for recording essential information in and reproducing the essential information from the optical disc is based on the principle of phase change where a signal is detected by a refractivity variation between crystalline and amorphous marks. Therefore, the optical disc, according to the present invention, including the essential information in the form of crystalline and amorphous marks is limited to optical discs capable of data recording by phase change. The present invention cannot be applied to read-only discs, such as CDs or DVD-ROMs, which do not employ the phase change principle.

The crystalline and amorphous marks in the recording layers 43a and 43b are formed as a series of radial bars that are formed in a circle around the center of the optical disc, between a clamping area and a power calibration area. For other optical discs, such crystalline and amorphous marks are formed between the clamping area and a lead-in area. For any recordable optical disc, regardless of whether it is a single-layer, multi-layer, single-sided, or double-sided optical disc, the essential information of the optical disc is recorded as crystalline and amorphous marks by crystallizing a portion of an essential information area in an amorphous recording layer after deposition of the amorphous recording layer.

The crystalline marks 40a and 40b have a higher reflectivity than the amorphous marks. The reflectivity of the crystalline marks 40a and 40b is not less than 20%. A binary alloy or ternary alloy including tellurium and selenium, which are susceptible to being amorphous, has been used as a main material for currently available recordable optical discs that record data by phase change. In particular, a ternary alloy of Te, Ge, and antimony exhibits a high absorbance in a predetermined wavelength region of a laser beam and a large difference in reflectivity between crystalline and amorphous phases.

An essential information recording method by phase change according to the present invention includes heating the recording layer of an optical disc to the temperature of crystallization by layer irradiation with proper timing in response to a photoelectrically converted essential information signal and slowly cooling the heated recording layer below the temperature of crystallization to form a crystalline mark, thereby resulting in a pattern of crystalline and amorphous marks.

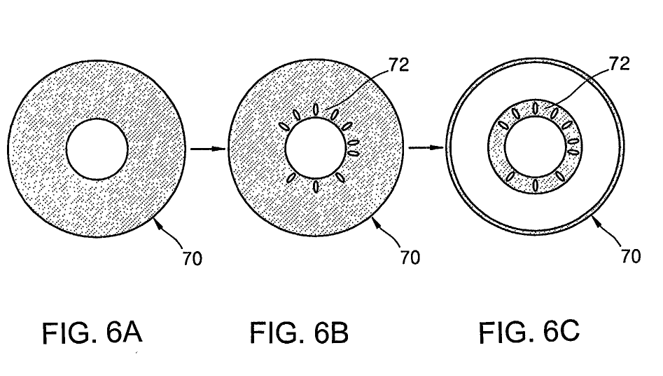

FIG. 5 is a flowchart illustrating an embodiment of the essential information recording method by phase change according to the present invention. Referring to FIG. 5, to record the essential information of an optical disc, a laser beam is first radiated onto the EIA of the recording layer. Next, the recording layer is heated above the temperature of crystallization. The temperature of the heated recording layer is slowly cooled to the temperature of crystallization or below to form a crystalline mark in a predetermined region of the EIA. Operations 101 through 107 are repeated to fully record the essential information of the optical disc. The essential information is recorded as a pattern of crystalline and amorphous marks.

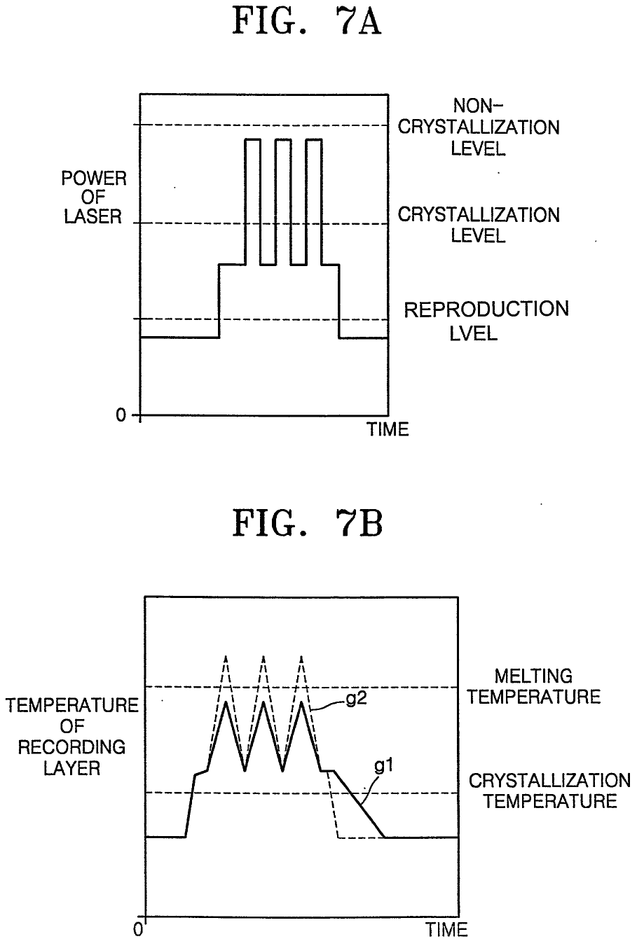

FIGS. 6A-6C show state changes of an optical disc when the essential information is formed on the optical disc using an essential information recording method according to an embodiment of the present invention. After mastering an optical disc 70, a recording layer is first formed on the optical disc 70 so that the entire optical disc 70 is in an amorphous phase, as shown FIG. 6A. The optical disc 70 shown in FIG. 6A is not fully but partially amorphous as it includes a small number of fine crystals. Next, as shown in FIG. 6B, a laser beam is radiated onto an EIA 72 of the recording layer by an optical pickup apparatus to initialize the optical disc 70.

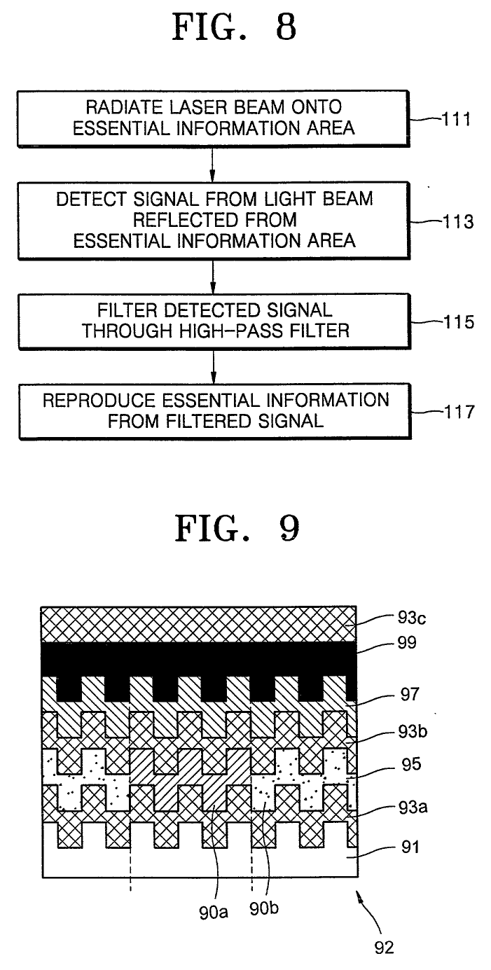

Next, the power of the laser beam is raised to a crystallization level, as shown in FIG. 7A, until the temperature of the recording layer heated by the laser beam reaches above the crystallization temperature and below a melting temperature, as shown in FIG. 7B.

Next, the temperature of the recording layer heated by the beam radiation is slowly lowered to the temperature of crystallization or below, as indicated by g1 in FIG. 7B. If the recording layer is heated above the melting temperature and is cooled rapidly, as indicated by g2, then the recording layer may change into an amorphous phase so that it cannot be distinguishable from a data area where information is recorded.

As a result, a crystalline mark is formed in the area of the recording layer exposed to the laser beam so that the essential information is recorded as a pattern of crystalline and amorphous marks, as shown in FIG. 6C.

The phase change in the EIA 72 of the recording layer differs from that in the data area. The temperature of the data area is raised to the melting temperature, whereas the temperature of the EIA 72 is raised to the temperature of crystallization lower than the melting temperature in the embodiment of the essential information recording method according to the present invention.

In other words, information is recorded in the data area by rapidly cooling the temperature of the recording layer heated to the melting point to form completely amorphous marks. Also, neighboring areas of the data area, in which information is not recorded, are slowly cooled after being heated to the melting point so that the neighboring areas are crystallized. In contrast, the EIA 72 is irradiated by a laser beam and slowly cooled to record the essential information as a pattern of crystalline and amorphous marks. Amorphous portions of the pattern are the portions of the initial amorphous recording layer which were not heated and crystallized.

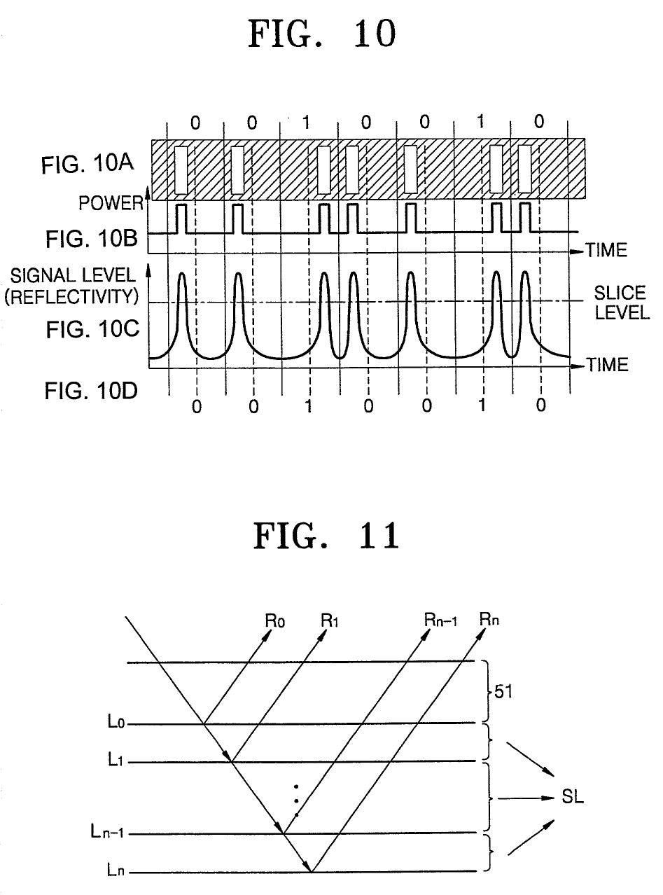

FIG. 8 is a flowchart illustrating an essential information reproducing method according to an embodiment of the present invention. The essential information reproducing method involves radiating a laser beam onto the EIA with a pattern of crystalline and amorphous marks, detecting an electrical signal converted from a light beam reflected from the EIA and received by a photodetector, filtering the detect signal through a high-pass filter, and reproducing the essential information from the filtered signal.

In a conventional optical disc, the reflectivity of a predetermined area of the recording layer, a portion of which has been physically removed from the recording layer to record a reflected signal from the BCA is filtered through a low-pass filter to reproduce a detection signal. In contrast, for a recordable optical disc according to an embodiment of the present invention in which the essential information is recorded as a pattern of crystalline and amorphous marks, the reflectivity of the crystalline mark is greater than that of the amorphous mark so that the reflected signal from the crystalline mark is filtered through a high-pass filter to reproduce the detection signal.

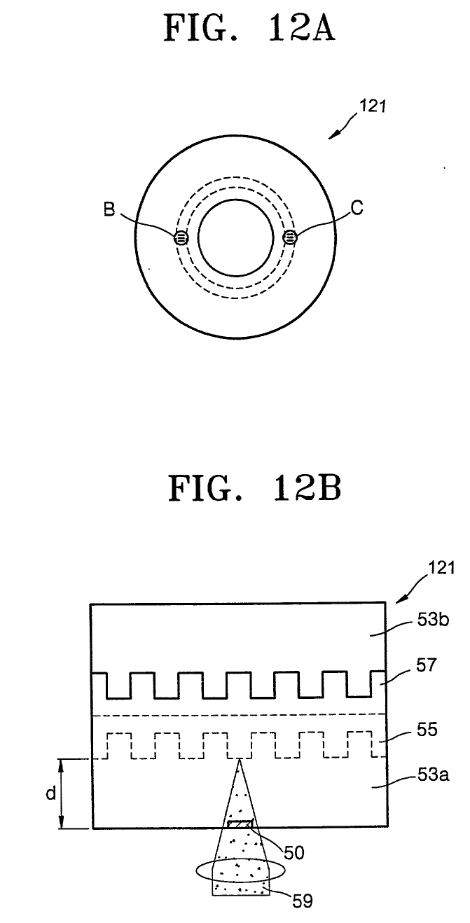

FIG. 9 shows a DVD-RAM 92 as an embodiment of the present invention where essential information is recorded. Referring to FIG. 9, the DVD-RAM 92 includes a protective layer 93a, a recording layer 95, a protective layer 93a, a reflective layer 97, an adhesive layer 99, and a protective layer 93c, which are sequentially formed on a substrate 91. As described above, a barcode type crystalline mark 90a is formed when a laser beam is radiated onto the recording layer 95, which is amorphous when deposited, until the power of the laser beam reaches a crystallization level.

Because the reflectivity of the crystalline mark 90a is higher than that of an amorphous mark 90b, a reproduction signal from the crystalline mark 90a becomes logic high, and a reproduction signal from the amorphous mark 90b becomes logic low.

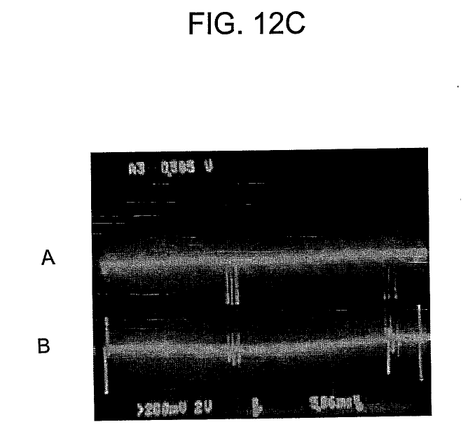

FIGS. 10A-10D are diagrams illustrating an essential information reproducing method according to the present invention with the assumption that data “0010010” is recorded as the essential information.

As shown in FIG. 10A, a barcode type mark appearing in a leading half of each period corresponds to “0”, and a barcode type mark appearing in the following half of each period corresponds to “1”. The laser power level applied to record the barcode type marks is shown in FIG. 10B. In FIG. 10C, a signal synchronized by high-pass filtering is shown. The reflectivity of the barcode type mark is higher than that of the neighboring areas where no barcode type mark is formed. As shown in FIG. 10D, data “0010010” which is identical to the data recorded as the essential information is reproduced.

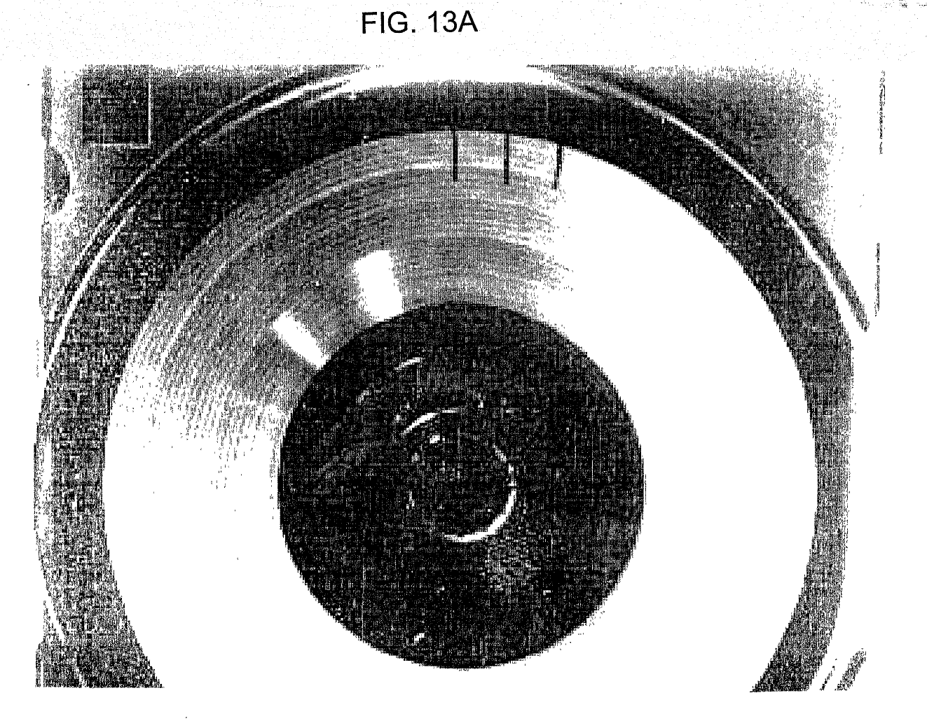

FIG. 11 shows the structure of a multi-layer optical disc according to another embodiment of the present invention. Referring to FIG. 11, the multi-layer optical disc includes a substrate 51 and a recording layer having multiple layers L₀ through Lₙ sequentially arranged on the substrate 51. In FIG. 11, R₀ through Rₙ denote the reflectivity of the respective multiple layers L₀ through Lₙ.

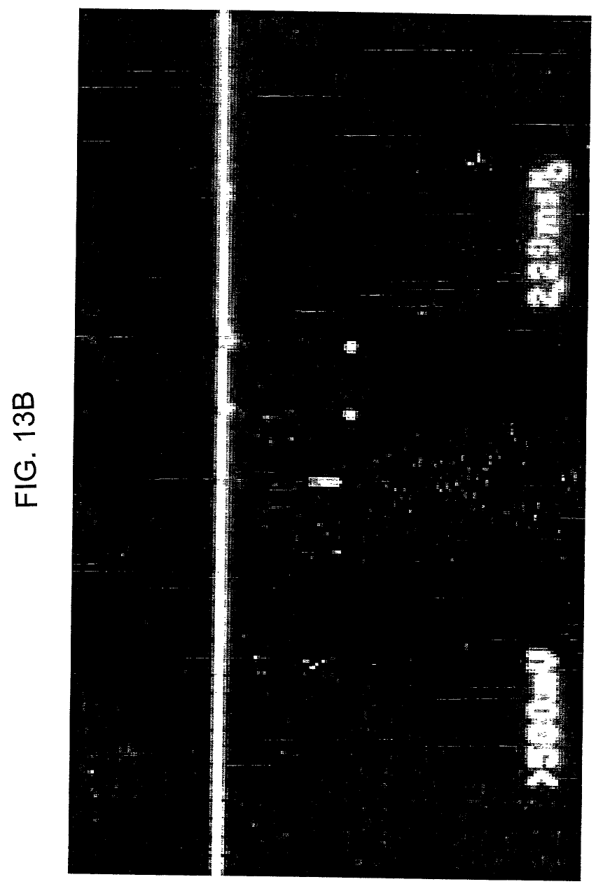

FIG. 12A is a plan view of a dual-layer optical disc having only the layers L₀ and L₁ of FIG. 11 in which barcode type marks B and C are formed at opposite sides of the disc by radiating a laser beam through a 0.6-NA objective lens onto the surface of the dual-layer optical disc 121 of a 0.6-mm thickness. FIG. 12B is a partial sectional view of the dual-layer optical disc shown in FIG. 12A.

Referring to FIG. 12B, in the dual-layer optical disc, a semi-transparent layer 55 as a recording layer, a reflective layer 57, and a protective layer 53b are sequentially arranged on a transparent substrate 53a. A barcode type mark 50 is formed on the surface of the transparent substrate 53a, and a laser beam 59 is focused onto the recording layer, the semi-transparent layer 55, through the barcode type mark 50.

FIG. 12C shows a mark signal reproduced by the essential information reproducing method according to an embodiment of the present invention. In FIG. 12C, A denotes a radio frequency signal appearing in Channel 1, and B denotes a tracking error signal. Even though there exists a focusing error of 0.6 mm corresponding to the substrate thickness d as shown in FIG. 12B, the mark signal reproduced from the surface of the substrate 53a is apparent in Channel 1.

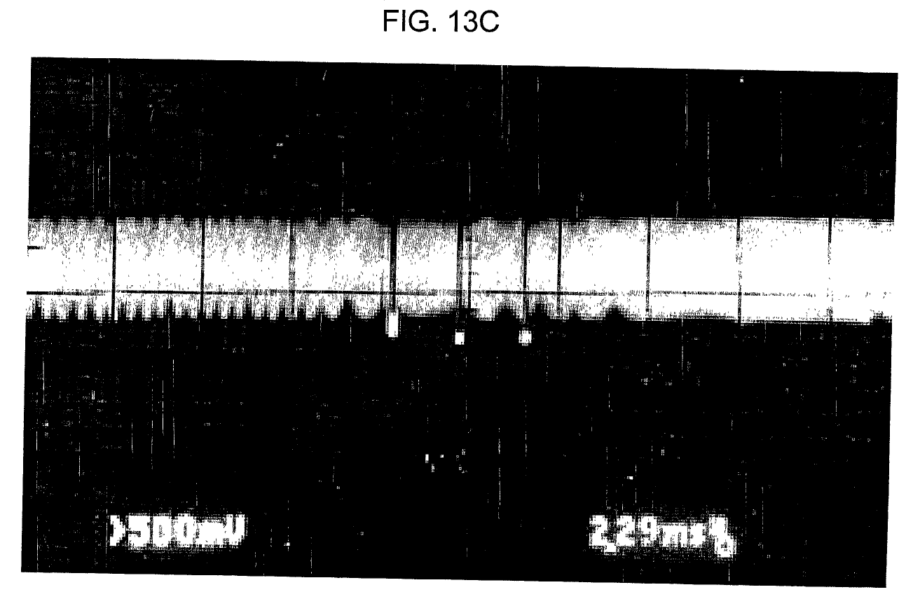

FIG. 13A shows an optical disc in which barcode type marks are formed on a protective layer 0.1 mm apart from a recording layer by radiating the laser beam through a 0.85-NA objective lens. FIG. 13B shows a mark signal detected by focusing the laser beam onto the recording layer 0.1 mm apart from the protective layer on which the barcode type marks are formed. FIG. 13C shows the mark signal detected by focusing the laser beam onto the protective layer having the barcode type marks. As shown in FIGS. 13B and 13C, the waveforms of the two signals are almost the same, even with a focusing error of 0.1 mm.

As is apparent from the results of the dual-layer optical disc, because a space layer formed between two layers L₀ and L₁ has a thickness no greater than 30-35 μm, a pattern of crystalline and amorphous marks formed in the layer L₀ to record essential information can be accurately reproduced by focusing a laser beam through a 0.65-NA objective lens onto the other layer L₁.

In another embodiment of the essential information reproducing method according to the present invention, it is not necessary to record the essential information in every recording layer of a multi-layer optical disc. In particular, once essential information is recorded as a barcode type mark in a predetermined layer of the multi-layer optical disc, the essential information can be reproduced as long as a laser beam, which is not focused, is radiated on the barcode type mark. In focusing and tracking to record data in or reproduce data from a multi-layer optical disc, if the essential information is recorded in the layer L₀, the essential information can be reproduced when a predetermined information layer is focused through the layer L₀ to read data therein or reproduce data therefrom.

Here, the level of a reproduction signal from the essential information recorded as a pattern of crystalline and amorphous marks is inverted to that of a reproduction signal from conventional BCA codes.

While this invention has been particularly shown and described with reference to embodiments thereof, the embodiments described above are merely illustrative and are not intended to limit the scope of the invention. Therefore, it will be understood by those skilled in the art that the essential information of an optical disc can be recorded in the form of any marks other than the barcode type marks. The essential information described above can be expressed in any code including the BCA code. Therefore, due to the diversity of this invention, the spirit and scope of the invention should be defined by the appended claims, rather than by the preferred embodiments described above.

As described above, the optical disc according to the present invention is advantageous in that the structure with a pattern of crystalline and amorphous marks as essential information can be applied to any type of recordable optical disc based on the principle of phase change, including single-layer and multi-layer discs.

An advantage of the method of recording essential information in an optical disc by phase change according to the present invention is that the essential information can be recorded at the same time as the optical disc is initialized using a conventional initializing apparatus without using any additional recording apparatus and consuming additional time for recording the essential information.

An advantage of the method of reproducing the essential information from the optical disc by phase change according to the present invention is that the essential information can be reproduced using the conventional optical pickup. In addition, for a multi-layer optical disc, once essential information is recorded in any layer of the multiple layers by phase change according to the present invention, the essential information can be reproduced easily due to the high reflectivity of the crystalline and amorphous marks with the crystalline phase.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical medium in which essential information is recorded as a pattern of crystalline and amorphous marks.

2. The optical medium of claim 1, wherein the crystalline and amorphous marks are in the form of barcodes extending in a radial direction.

3. The optical medium of claim 2, wherein the crystalline and amorphous marks are arranged in a circle around the center of the optical medium apparatus.

4. The optical medium of claim 1, wherein the crystalline marks have a higher reflectivity than the amorphous mark.

5. The optical medium of claim 4, wherein the crystalline marks have the reflectivity of no less than 20%.

6. A multi-layer optical medium, comprising:
a plurality of recording layers in which essential information is recorded as a pattern of crystalline and amorphous marks.

7. The multi-layer optical medium of claim 6, wherein the crystalline and amorphous marks are in the form of barcodes extending in a radial direction.

8. The multi-layer optical medium of claim 7, wherein the crystalline and amorphous marks are arranged in a circle around the center of the optical medium apparatus.

9. The multi-layer optical medium of claim 6, wherein the crystalline marks have a higher reflectivity than that of the amorphous mark.

10. The multi-layer optical medium of claim 9, wherein the crystalline marks have the reflectivity of no less than 20%.

11. An optical medium, comprising:
a layer having an area for storing essential information representing a characteristic of the optical medium; and
a plurality of crystalline and amorphous marks formed in the layer.

12. The optical medium of claim 11, wherein the amorphous marks are disposed between the crystalline marks.

13. The optical medium of claim 11, wherein the crystalline and amorphous marks represent a burst cutting area code.

14. The optical medium of claim 11, wherein the layer comprises a user data area for storing user data other than the characteristic of the optical medium, the crystalline and amorphous marks of the layer spaced-apart from the user data area.

15. The optical medium of claim 11, wherein the layer comprises a clamp area and a lead-in area, the crystalline and amorphous marks of the layer disposed between the clamp area and the lead-in area.

16. The optical medium of claim 11, further comprising a lead-in area formed between the essential area and the user data area, wherein the essential area is spaced apart from the user data area.

17. The optical medium of claim 11, wherein the optical medium is a recordable optical disc.

18. The optical medium of claim 11, wherein the amorphous marks are amorphous portions between the crystalline marks of the essential area.

19. The optical medium of claim 11, wherein crystalline and amorphous marks represent one of a serial number and a manufacturing date of the optical medium.

20. The optical medium of claim 11, further comprising another layer having a reflectivity different from that of the layer, wherein the another layer transmits a beam reflected from the crystalline marks of the layer to an outside of the optical medium using the different reflectivity of the layers when the beam is not focused on the layer.

21. The optical medium of claim 20, wherein the another layer is an outer surface layer of the optical medium.

22. The optical medium of claim 20, wherein the another layer is a transparent layer.

23. The optical medium of claim 20, wherein the another layer is closer to an outer surface of the optical medium than the layer.

24. An optical medium having a plurality of layers, comprising:
an essential area formed on one of the layers;
user data areas formed on respective layers;
crystalline and amorphous marks formed on the essential area of the one of the layers; and
amorphous marks formed on the user data areas of the respective layers.

25. The optical medium of claim 24, wherein essential information is stored in the essential area in the form of the crystalline and amorphous marks.

26. The optical medium of claim 24, wherein the crystalline and amorphous marks are in the form of barcodes representing a burst cutting area code.

27. The optical medium of claim 24, wherein the amorphous marks formed on the respective user data areas of the layers store user data other than essential information data stored in the essential area.

28. The optical medium of claim 24, wherein essential information contained in the crystalline and amorphous marks is reproduced through a beam reflected from the respective layers when the beam is not focused on the one of the layers.

29. The optical medium of claim 24, wherein the one of the layers includes one of the user data areas.

30. A method of recording essential information in an optical medium, the method comprising:
heating portions of an amorphous recording layer above a crystallization temperature and below a melting temperature by radiating a beam according to a photoelectrically converted signal; and
cooling the heated portions of the amorphous recording layer to the crystallization temperature or below to form crystalline and amorphous marks.

31. The method of claim 30, wherein the optical medium comprises a plurality of recording layers.

32. The method of claim 30, wherein the crystalline and amorphous marks are in the form of barcodes extending in a radial direction.

33. The method of claim 30, wherein the crystalline and amorphous marks are arranged in a circle around the center of the optical medium.

34. The method of claim 30, wherein the crystalline marks have a higher reflectivity than the amorphous mark.

35. The method of claim 34, wherein the crystalline marks have the reflectivity of no less than 20%.

36. A method of reproducing essential information from an optical medium, the method comprising:
radiating a beam onto a layer having a pattern of crystalline and amorphous marks in which the essential information of the optical medium is recorded;
receiving the beam reflected from the layer having the pattern of crystalline and amorphous marks and photoelectrically converting the received beam into a signal;
filtering the converted signal through a high-pass filter; and
reproducing the essential information of the optical medium from the filtered signal.

37. The method of claim 36, wherein the crystalline and amorphous marks are in the form of barcodes extending in a radial direction.

38. The method of claim 37, wherein the crystalline and amorphous marks are arranged in a circle around the center of the optical medium apparatus.

39. The method of claim 38, wherein the crystalline marks have a higher reflectivity than the amorphous mark.

40. The method of claim 39, wherein the crystalline marks have the reflectivity of no less than 20%.

41. A method in an optical medium apparatus having an amorphous layer, comprising:
forming a plurality of crystalline and amorphous marks in a predetermined area of the amorphous layer for storing essential information representing a characteristic of the optical medium.

42. The method of claim 41, wherein the forming comprises generating a laser beam on a portion of the layer to form the crystalline and amorphous marks.

43. The method of claim 41, further comprising:
heating portions of the layer to a heating temperature between a crystallization temperature and a melting temperature; and
cooling the heated portions of the layer below the crystallization temperature to form the crystalline marks.

44. The method of claim 41, further comprising changing portions of the layer from an amorphous state to a crystalline state to form the crystalline marks.

45. The method of claim 41, wherein the amorphous marks are disposed between the crystalline marks.

46. The method of claim 41, wherein the crystalline and amorphous marks are in the form of a barcode mark.

47. The method of claim 41, wherein the crystalline and amorphous marks of the layer are spaced-apart from a user data area for storing user data other than the essential information of the optical medium.

48. The method of claim 41, wherein the crystalline and amorphous marks of the layer are disposed between a clamp area and a lead-in area of the optical medium.

49. The method of claim 41, wherein the crystalline and amorphous marks of the layer are disposed between a clamp area and one of a power calibration area, a program memory area, and a user data area of the optical medium.

50. The method of claim 41, wherein the essential information of the optical medium corresponds to one of a serial number of the optical medium and a manufacturing date of the optical medium.

51. The method of claim 41, wherein a crystalline m ark of the crystalline marks has a higher reflectivity than an amorphous mark of the amorphous marks formed in the layer.

52. The method of claim 41, wherein a crystalline mark of the crystalline marks has a reflectivity of no less than 20%.

53. The method of claim 41, further comprising:
generating a laser beam incident onto the crystalline and amorphous marks of the layer of the optical medium;
receiving a reflected beam reflected from the crystalline and amorphous marks of the layer of the optical medium; and
filtering the reflected beam through a high pass filter to generate a filtered signal.

54. The method of claim 53, further comprising generating one of a serial number and a manufacturing date of the optical medium in accordance with the filtered signal.

55. The method of 41, wherein portions of the layer are changed from an amorphous state to a crystalline state to form the crystalline and amorphous marks.

56. The method of claim 41, wherein the layer is one of a recording layer and a protective layer of the optical medium.

57. A method in an optical medium having an essential area and a user area, comprising:
heating portions of the essential area to a heating temperature between a crystalline temperature and a melting temperature to record essential information.

58. The method of claim 57, wherein the heating in the essential area is to form crystalline marks.

59. The method of claim 57, further comprising:
heating portions of the user area above the melting temperature to form amorphous marks.

60. The method of claim 57, wherein the essential area stores a burst cutting area code in the form of the crystalline marks in the essential area.

61. The method of claim 57, wherein the optical medium is a recordable optical disc.

62. The method of claim 57, further comprising:
a first layer and a second layer, wherein the essential area is formed on the first layer while the user area is formed on either one of the first and second layers.

63. The method of claim 62, further comprising:
radiating a beam on the second layer: and
reproducing the essential information contained in the essential area of the first layer from the beam reflected from the second layer through the first layer.

64. The method of claim 63, wherein the essential information is reproduced when the beam is not focused on the first layer.

65. A method in an optical medium having a plurality of layers, comprising:
recording essential information data in only one of the plurality of layers in the form of crystalline marks.

66. The method of claim 65, wherein the essential information is reproduced from a beam passing through the layers when the beam is focused on any one of the layers.

67. The method of claim 65, wherein the layers have a different reflectivity.

68. A method of recording data in an optical medium, comprising:
generating a laser beam with a first temperature between a crystalline temperature and a melting temperature to form crystalline marks in an essential area of the optical medium; and
generating the laser beam with a second temperature above the melting temperature to form amorphous marks in a user data area of the optical medium other than the essential area.

69. A method in an optical medium, comprising:
forming a substrate;
forming a plurality of layers formed on the substrate, the layers having a different reflectivity;
forming an essential area in one of the layers; and
forming crystalline marks in the essential area for storing essential information.

70. The method of claim 69, further comprising:
reproducing the essential information from a beam reflected from any of the layers using the different reflectivity when the beam is incident into the optical medium.
